(19) United States
(12) Patent Application Publication
(10) Pub. No.: US 2012/0061435 A1
(43) Pub. Date: Mar. 15, 2012

(54) Aerodynamic Bicycle Storage Pack Assembly

(76) Inventor: Michael Lavery, Madison, WI (US)

(21) Appl. No.: 12/879,571

(22) Filed: Sep. 10, 2010

(51) Int. Cl. B62J 9/00; B23P 17/00

(52) U.S. Cl. 224/427; 224/435; 29/592

(57) ABSTRACT

A bicycle storage pack assembly that compliments the aerodynamic shape of a bicycle frame and is supported only by interaction with the seat stays of the bicycle. The storage pack assembly includes a housing that defines an accessory storage cavity and a clamp body movably connected to the housing. The housing and the clamp body are each shaped to extend in a lateral direction over the seat stays to maintain the housing in abutting engagement with a seat tube of the bicycle. Preferably, the assembly includes a movable cover that is tethered to the housing. Preferably, one or more of the housing, clamp body, and cover are formed of glass filled nylon material.

### BACKGROUND OF THE INVENTION

The present invention relates generally to bicycle accessory storage systems and, more particularly, to a storage pack that compliments the aerodynamic performance of the underlying bicycle and that is fully supported by the seat stays at a position generally beneath the bicycle seat.

Several different forces oppose the movement of a bicycle in use. A major force acting against the movement of the bicycle is the drag induced by the bicycle's movement through the air. Although this force is not particularly problematic for recreational riders, such drag forces are problematic for aggressive, athletic, and/or professional riders. The faster the movement of a bicycle, the greater the drag force becomes. Greater drag requires the rider to expend greater energy to overcome the drag forces and detrimentally affects timed rider performance. Accordingly, reducing the drag forces is an important consideration in competitive cycling.

A major source of drag on a bicycle results from the flow of air over and around the entirety of the bicycle assembly. Although the frame of a bicycle can be constructed to substantially minimize the negative effects of drag, each component attached to the bicycle frame and exposed to the air flow thereover alters the aerodynamic performance of the bicycle. Dramatic changes in the contour of the bicycle and components connected thereto can introduce increased levels of undesirable drag. One component commonly connected to a bicycle is an accessory storage system. Commonly, athletic and competitive riders participate in races or rides of extended duration as a test of endurance and stamina. These rides generally require the cyclist to carry several accessories to better the odds of ride completion. Such accessories can include spare tires, tire filling devices such as pumps or CO2 bottles, rain gear, multi-function tools, and the like. Such devices are merely exemplary and a rider may attach anything to the bicycle that they believe may be required during a ride to maintain either the bicycle or the rider.

Although being configured to support multiple cycling accessories, many known accessory mounting systems do not adequately address the aerodynamic impact of the accessory mounting or storage systems or the accessories and suffer from other drawbacks as well. Commonly, a number of interconnecting links are fastened together about a portion of a frame of a bicycle. A number of fasteners secure the relative location of each of the links. The interconnecting links and associated fasteners present the potential for marring the finish of the frame, require extensive assembly time, and are frequently less than aesthetically pleasing. Additionally, the use of multiple fasteners presents the potential for the fasteners coming loose during bicycle operation. That is, shocks and vibrations generated during a ride can loosen the fasteners which results in an obnoxious rattle and/or loss of the desired accessories or accessory storage system. Additionally, these same vibrations can result in premature failure of any one of the interconnecting links.

Although certain accessory storage systems provide generally open mounting locations, such systems detract from the appearance of the bicycle and expose each of the accessories to the aerodynamic effects discussed above. Dissatisfied with such features, many riders are familiar with enclosed accessory storage systems. Such closed storage containers are commonly referred to as “bike packs” and such systems that are commonly intended to be secured near the bicycle seat. One particular type of bike pack is commonly referred to as a “seat pack.” Seat packs are configured to be suspended from the rails or other downward facing structure of the bicycle seat whereas storage packs are commonly secured to structures of the bicycle other than the seat. Most seat packs and some storage packs generally provide small enclosures and are configured to be positioned in the space between the underside of the seat, rearward of the seat post or seat tube, and above the seat stays although many storage packs are configured to be supported at other locations as well. Storage packs generally enclose a space or cavity sized to accommodate any of a number of bicycle or rider related accessories. Storage packs must commonly have a generally large opening for accommodating larger rigid accessories and/or a rider's hand or fingers and/or be quickly removable from the bicycle so that accessories can be dumped therefrom. Such openings are generally rearward facing to improve the user's access to the contents of the storage pack. Such storage packs generally protect the accessories from weather and/or road debris or dirt but are not without their respective drawbacks.

Many storage packs are commonly secured to one or more of the bicycle seat tube and/or the bicycle seat post, whereas most seat packs are secured to the seat rails that extend along the underside of the seat. Unfortunately, such mounting arrangements have various drawbacks. Storage packs that cooperate with only the generally vertical structure of the seat post or seat tube can become loose so that the clamping structure of the storage pack may move in an up and down direction along the structure of the bicycle during operation of the bicycle. Such movement can result in the undesirable noise and/or marring of the bicycle components as discussed above. Furthermore, as the clamping forces are oriented in a direction that is generally normal to gravitation and road forces, such clamping systems must be fairly robust to provide a clamping pressure sufficient to withstand the cantilevered loading associated with the accessories contained in the storage pack. The robust nature of the clamping arrangement also undesirably affects the collective weight of the bicycle and particularly the weight attributable to the storage pack. Although supplementing the storage pack mounting arrangement with one or more structures that cooperate with the seat rails to mimic seat pack mounting arrangements reduces the potential for vertical oscillation of the storage pack, such structures complicate the storage pack mounting arrangement and exacerbate the drawbacks associated with the weight attributable the storage pack assembly.

Seat post, seat tube, and/or seat rail storage or seat pack mounting systems also negatively affect the aerodynamic performance associated with the underlying bicycle. Commonly, the clamping arrangement results in the body or container of the storage or seat pack being offset from the seat post or seat tube so that a gap or substantial discontinuity is formed between the contours of the seat post or seat tube and the body of the storage or seat pack. This discontinuity increases the drag attributable to the storage or seat pack assembly and detracts from the aerodynamic performance of the bicycle and storage or seat pack assembly.

Accordingly, there is a need for a storage pack assembly that can be quickly and conveniently connected to an underlying bicycle and that allows a rider quick and convenient access the accessories enclosed therein. There is also a need for a bicycle storage pack assembly that is lightweight and robust and provides improved aerodynamic performance.

### BRIEF DESCRIPTION OF THE INVENTION

The present invention provides a storage pack assembly and method of providing a bicycle accessory storage system that overcomes one or more of the aforementioned drawbacks. One aspect of the invention discloses a bicycle storage pack assembly that compliments the aerodynamic shape of a bicycle frame and that is supported by interaction with only the seat stays of the bicycle frame. The storage pack assembly includes a housing that defines an accessory storage cavity and a clamp body that is movably connected to the housing. The housing and the clamp body are each shaped to extend laterally over the seat stays to maintain the housing in abutting relation to a seat tube or seat stem of the bicycle. Preferably, the assembly includes a movable cover that is tethered to the housing. Preferably, one or more of the housing, clamp body, and cover are formed of a glass filled or reinforced nylon material.

A bicycle storage pack assembly according to another aspect of the invention useable with one or more of the above aspects includes a housing that defines a storage cavity and a clamp body that is movably connected to a bottom portion of the housing. A forward facing wall of the housing has a shape that corresponds to a rearward facing wall of at least one of a seat tube and a seat post of a bicycle frame. The clamp body has at least one arm that is shaped to engage a seat stay of the bicycle frame so that the seat stay can be captured between that the housing and the clamp body to secure the housing in abutting engagement with one of the seat tube and the seat post by only the seat stays.

Another aspect of the invention that is useable with one or more of the above aspects discloses a bicycle accessory storage device having a container body that is adapted to be attached to a bicycle at a location generally rearward of a seat tube and between a seat stay and a saddle. The container body has a forward facing side wall that abuts a rearward facing side of the seat tube. The device includes a clamp connected to a lower portion of the container body. The clamp is movable relative to the container body to capture the seat stay between the clamp and the container body to maintain the forward facing side wall of the container in abutting engagement with the rearward facing side of the seat tube.

A further aspect of the invention useable with one or more of the above aspects discloses a method of providing a bicycle accessory storage system that is positionable outboard of the frame triangle and between the seat and seat stays. The method includes forming a body that defines a cavity for receiving at least one bicycle accessory. The body is shaped to cooperate with a seat tube of the bicycle frame so that a horizontal cross section of the body and the seat tube aerodynamically compliment one another. A clamp movably cooperates with the body to be movable along an axis that is oriented in a crossing direction with respect to the horizontal cross section of the body that defines the cavity. A portion of the body extends laterally over an upper surface of a pair of seat stays and the clamp extends laterally over a lower surface of the pair of seat stays so that each of the seat stays are captured between the body and the clamp so that the bicycle accessory storage system is supported by only the seat stays.

Another aspect of the invention useable with one or more of the above aspects discloses a cover that moveably cooperates with the body or housing of the container. The cover cooperates with an end of the housing generally opposite the clamp. Preferably, one of the cover and the housing includes one or more catches and the other of the cover and housing includes one or more passages that cooperate with the catches to removably secure the cover to the housing. Preferably each catch is pivotably connected to the cover by a living hinge. More preferably, the catches and passages are formed on opposite lateral sides of each of the cover and the housing. Preferably, the cover is tethered to the housing by a lanyard or the like so that the cover is movable with respect to the container but is not removable therefrom. Preferably, one or more of the cover, the container, and the clamp are formed of nylon material and more preferably, are formed of glass filled nylon material.

These and various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a side elevation view of a bicycle equipped with a bicycle storage pack assembly according to the present invention;

FIG. 2 is a rear elevational view from plane 2-2 shown in FIG. 1 of the storage pack assembly shown in FIG. 1;

FIG. 3 is an exploded perspective view of the storage pack assembly shown in FIG. 2;

FIG. 4 is an elevational cross-sectional view of the storage pack assembly shown in FIG. 2 and taken along line 4-4 shown in FIG. 3;

FIG. 5 is a horizontal cross-sectional view of the storage pack assembly and the adjacent bicycle structure taken along line 5-5 shown in FIG. 4; and

FIG. 6 is a graph that shows the improved aerodynamic performance provided by the storage pack assembly shown in FIG. 1.

### DETAILED DESCRIPTION OF THE PREFERRED EMBODIMENT

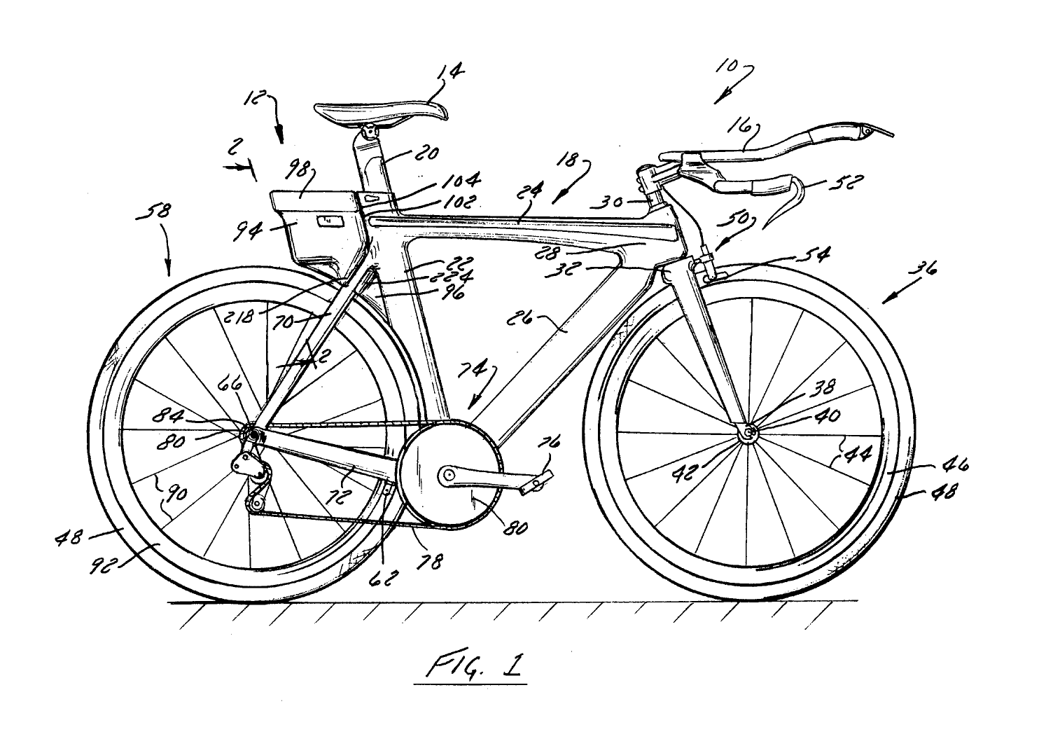

FIG. 1 shows a bicycle 10 having an accessory storage device or storage pack assembly 12 according to the present invention. Bicycle 10 includes a seat 14 and handlebars 16 that are attached to a frame assembly 18. A seat post 20 is connected to seat 14 and slidably engages a seat tube 22 of frame assembly 18. Storage pack assembly 12 is shape and constructed to be attached to bicycle 10 at a location outboard of the main triangle of frame assembly 18 generally beneath seat 14 and rearward of seat post 20 and seat tube 22 but without interaction or supporting cooperation with the underside of seat 14 as is common to seat packs. The main triangle of frame assembly 18 includes a top tube 24 and a down tube 26 that extend forward from seat tube 22 to a head tube 28 of frame assembly 18. Handlebars 16 are connected to a stem 30 that passes through head tube 28 and engages a fork crown 32. A pair of forks 34 extend from generally opposite ends of fork crown 32 and are constructed to support a front wheel assembly 36 at an end of each fork or a fork tip 38. Fork tips 38 engage generally opposite sides of an axle 40 that is constructed to engage a hub 42 of front wheel assembly 36. A number of spokes 44 extend between hub 42 and a rim 46 of front wheel assembly 36. A tire 48 is engaged with rim 46 such that hub 42, rim 46, and tire 48 rotate relative to forks 34.

Bicycle 10 includes a front brake assembly 50 having an actuator 52 attached to handlebars 16 and a pair of brake pads 54 positioned on generally opposite sides of front wheel assembly 36. Brake pads 54 are constructed to engage rim 46 of front wheel assembly 36 to provide stopping or slowing forces to front wheel assembly 36. Bicycle 10 includes a rear wheel assembly 58 that is attached to frame assembly 18. A rear brake assembly 62 is supported by alternate chain stays 72 and oriented to engage alternate lateral sides of rear wheel assembly 58 to provide slowing or stopping forces to rear wheel assembly 58. An axle 66 supports rear wheel assembly 58 relative to bicycle frame assembly 18. Rear wheel assembly 58 is positioned generally concentrically about rear axle 66. Although each of rear and front wheel assemblies 36, 58 are shown to interact with what are commonly referred to as rim caliber brake assemblies, it is appreciated that bicycle 10 could be provided so that one or both of front wheel assembly 36 and rear wheel assembly 58 interact with other brake assemblies such as disc brake assemblies which generally include a disc that is attached to the respective wheel assembly nearer the respective axle 40, 66.

Rear wheel assembly 58 is rotationally connected to frame assembly 18. A pair of seat stays 70 and a pair of chain stays 72 extend in a generally rearward direction from seat tube 22 and offset rear axle 66 in a rearward direction from a crankset 74. As is commonly understood, a seat stay 70 and a chain stay 72 are positioned on each of the generally opposite lateral or right hand and left hand sides of bicycle 10 as determined by the position of a rider oriented for operation of bicycle 10. As used herein, the longitudinal direction of bicycle 10 is that direction of bicycle 10 generally aligned with the longitudinal axis of bicycle 10 or the forward and rearward directions associated with bicycle travel directions and the lateral directions are those directions oriented to the alternate right and left sides of bicycle 10. As used herein, outboard directions of bicycle frame assembly 18 are those directions that radiate in all directions from frame assembly 18 which includes the main frame triangle as well as seat stays 70 and the chain stays 72.

Bicycle 10 is driven by rider operation of a crankset 74 via interaction with pedals 76 that extend in opposite lateral directions from bicycle 10. Crankset 74 is operationally connected to flexible drive member, such as a chain 78, via a chain ring or sprocket 80. Rotation of chain 78 communicates a drive force to a gear cluster 84 that is concentrically oriented and attached to the rotating structure of rear wheel assembly 58. Gear cluster 84 is generally concentrically orientated with respect to rear axle 66 and includes a number of variable diameter gears. Gear cluster 84 is operationally connected to a hub 86 of rear wheel assembly 58. A number of spokes 90 extend radially between hub 86 and a rim 92 of rear wheel assembly 58. As is commonly understood, rider operation of pedals 76 drives chain 78 thereby driving rear wheel assembly 58 which in turn propels bicycle 10.

Understandably, bicycle 10 is shown as what is commonly understood as a road bike or a bicycle intended to be ridden primarily upon paved surfaces. The construction of bicycle 10 is merely exemplary with respect to application of the present invention. It is appreciated that the present invention is equally applicable to other bicycle constructions such as cross-over, off-road, or mountain bikes. Although cross-over bicycles are also intended to be ridden primarily upon paved surfaces, such bicycles also tolerate operation on more uneven surfaces such as gravel roads or unpaved paths. Bicycles intended primarily for off-road operation are commonly equipped with front and/or rear wheel suspension systems that are disposed between the connection of the wheels and the frame of the bicycle to improve rider comfort associated with traversing uneven terrain. Understandably, regardless or the terrain intended to be traversed by the bicycle, many riders desire to carry various accessories with them during a ride. Accordingly, storage pack assembly 12 is configured to allow a rider to connect a number of accessories to the bicycle 10 and does so in a manner that encloses the accessories from the ride environment. As many riders include more than one bicycle, storage pack assembly 12 is also constructed such that, when the storage pack assembly 12 is removed from one bicycle, the assembly remains complete without supplemental brackets that remain attached to the first bicycle. Such a construction allows a rider to quickly and conveniently transfer storage pack assembly 12 from one bicycle to another.

Storage pack assembly 12 includes a housing body, body, or housing 94, a clamp body or clamp 96 that removably cooperates with housing 94, and a cover 98 that movably or removably cooperates with housing 94. Preferably, an optional lanyard or tether 100 connects cover 98 and housing 94. As shown in FIG. 1, storage pack assembly 12 includes a forward facing wall, surface, or end 104 that is maintained in close proximity, preferably touching or abutting, to a rear facing wall, surface, or end 102 of seat post or stem 20 or seat tube 22 of bicycle 10 when storage pack assembly 12 is attached thereto. Although housing 94, clamp 96, and cover 98 could be constructed of any of a number of materials or different materials including glass or fiber reinforced materials, such as carbon fiber materials, housing 94, clamp 96, and cover 98 are preferably constructed of a glass filled nylon material.

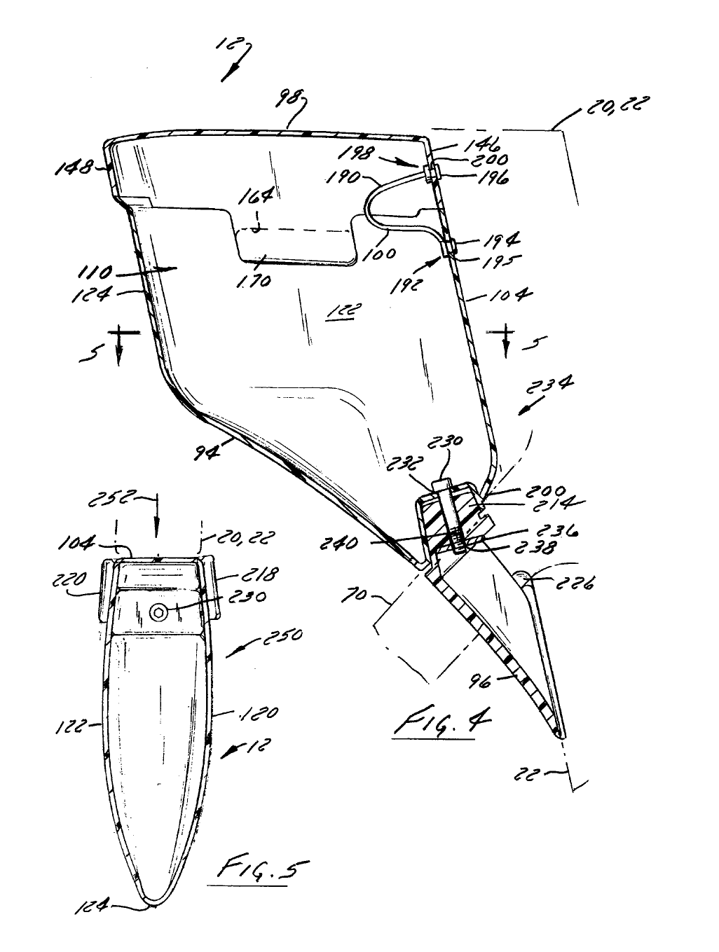

As described further below, housing 94 and cover 98 are preferably constructed to cooperate with one another so as to define a storage space or cavity 110 (FIG. 4) that is sized to receive one or more of any number of bicycling accessories such as a gas source, gas source tire filling device, a spare tire, rain gear, a multi-tool, gloves, etc. Still referring to FIG. 1, storage pack assembly 12 is positionable generally beneath seat 14, rearward of seat stem 20, rearward of seat tube 22, and mostly above seat stays 70. More preferably, storage pack assembly 12 is offset in a downward direction from the bottom surface of seat 14 to allow rider interaction with and removal of cover 98 from housing 94 in a manner that does not require the removal of storage pack assembly 12 from the underlying bicycle 10.

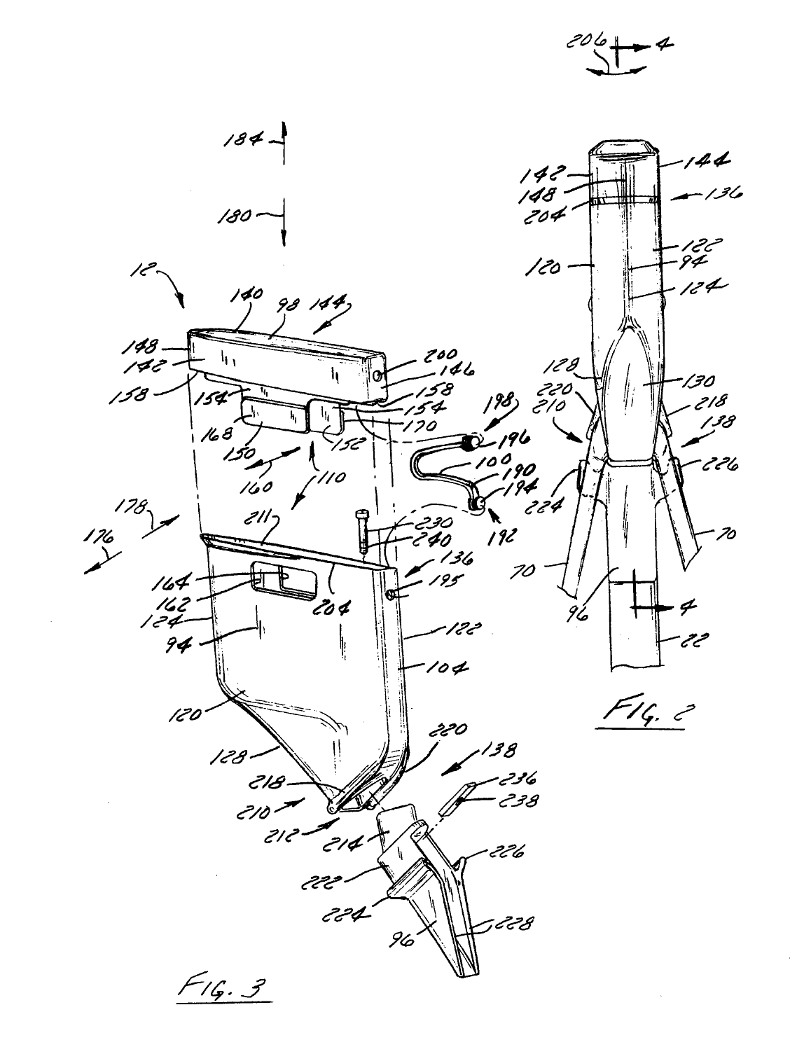

Referring to FIGS. 2 and 3, housing 94 includes a pair of opposite lateral sidewalls 120, 122 that extend in a generally rearward direction from front wall 104. Sidewalls 120, 122 terminate at a trailing edge 124 that extends generally vertically along the rearmost portion of housing 94. A lower end 126 of trailing edge 124 bifurcates into a first edge 128 and a second edge 130 that extend in a downward and forward direction toward clamp 96. It is appreciated that trailing edge 124 could also be configured to form a generally continuous single seam along a rear of housing 94 and between upper edge 136 and a bottom edge 138 of housing 94.

Still referring to FIGS. 2 and 3, cover 98 includes a top surface 140, a pair of side surfaces 142, 144, a forward surface 146, and a trailing edge 148. A pair of projections, tabs, or catches 150, 152 extend in a generally downward direction from each of side surfaces 142, 144 of cover 98. A pivot or hinge, such as a living hinge 154, attaches each catch 150, 152 to a lower edge 158 of each side surface 142, 144 of cover 98. Catches 150, 152 are deflectable about living hinges 154 in inward and outward lateral directions, indicated by arrow 160, relative to cover 98. As described further below, inward deflection of catches 150, 152 by a user allows cover 98 to be selectively removed from and secured to housing 94.

Side surfaces 120, 122 of housing 94 each include an opening 162, 164 shaped to receive a respective catch 150, 152. It is appreciated that the association of catches 150, 152 with cover 98 and openings 162, 164 with housing 94 could be reversed so that the catches extend from the housing and the cover removably cooperates therewith. Regardless of the specific orientation of catches 150, 152 ad openings 162, 164, user interaction with catches 150, 152 allows a protruding portion 168, 170 of each catch 150, 152 to selectively cooperate with a corresponding opening 162, 164 formed in housing 94. Preferably, protruding portions 168, 170 are biased in a slightly laterally outward direction, indicated by arrows 176, 178 relative to housing 94 such that cover 98 snap fittingly cooperates with housing 94 when cover 98 is translated in a downward direction, indicated by arrow 180, relative to housing 94 until protruding portions 168, 170 snap fit into openings 162, 164. User deflection of catches 150, 152 in a laterally inward direction allows protruding portions 168, 170 of catches 150, 152 to disengage from openings 162, 164 such that cover 98 can be translated in a generally upward direction, indicated by arrow 184, relative to housing 94 thereby effectively exposing cavity 110 to atmosphere and/or opening storage pack assembly 12.

Still referring to FIGS. 2 and 3, optional tether 100 includes an elongated body 190 having a first end 192 with a projection 194 formed thereat. Projection 194 snap fittingly cooperates with an opening 195 formed in forward facing wall 104 of housing 94. A second projection or stop 196 is formed at a second end 198 of tether 100. An opening 200 is formed in forward surface 146 of cover 98 and shaped so that stop 196 slidably or snap fittingly can be biased therethrough so that elongated body 190 of tether 100 between projection 194 and stop 196 is contained nearly entirely within storage 12. Preferably, stop 196 is constructed so as to forcibly passable through opening 200 in cover 98 but without sufficient force, prevents the removal of cover 98 from tether 100 and thereby secures cover 98 to housing 94. It is appreciated that tether 100 may be formed in any of a number of ways including as the flexible member or cord as shown and can be secured to the interior or exterior surfaces of housing 94 and cover 98. As shown in FIG. 2, when tether 100 is engaged with housing 94, elongated body 190 of tether 100 collapses and/or overlaps itself so that near the entirety of tether 100 is contained within storage pack assembly 12. When disengaged from housing 94, the flexible nature of tether 100 allows cover 98 to hang generally below an upper edge 204 of housing 94 such that cover 98 can rotate in generally lateral directions, indicated by arrow 206, relative to housing 94 so as to nearly fully expose the opening 211 (FIG. 3) bounded by upper edge 204 of housing 94.

A lower end 210 of housing 94 includes an opening or a pocket 212 that slidably receives a stem 214 of clamp 96. Pocket 212 and stem 214 have substantially similar contours such that stem 214 can be snugly received within pocket 212 and positionally orients clamp 96 relative to housing 94. Housing 94 includes stay support surfaces 218, 220 that generally flank pocket 212. As described further below, when storage pack assembly 12 is engaged with bicycle 10, stays 70 of bicycle 10 are captured between stay support surfaces 218, 220 of housing 94 and clamp 96. Clamp 96 includes an offset 222 that extends in a downward direction from stem 214. Clamp 96 includes a first arm 224 and a second arm 226 that extend in opposite outward lateral directions from clamp 96. Clamp 96 includes two tube ramps 228 that generally abut seat tube 22 of bicycle 10 when storage pack assembly 12 is engaged therewith. Tube ramps 228 provide a robust support for the cantilevered orientation of housing 94 and complete an aerodynamic cross sectional shape of seat tube 22 proximate clamp 96.

Referring to FIGS. 3 and 4, a fastener 230 passes through an opening 232 formed in lower portion 234 of housing 94. Fastener 230 engages housing 94 and extends into pocket 212. A nut or nut plate 236 that includes a threaded opening 238 is configured to the threadingly receive a threaded portion of a shaft 240 of fastener 230. Although nut plate 236 is shown as removably cooperating with clamp 96, it is appreciated that the operative connection between clamp 96 and fastener 230 could be integrally formed in or with clamp 96. Regardless of the specific configuration of nut plate 236, when fastener 230 is engaged with nut plate 236, manipulation of fastener 230 draws stem 214 of clamp 96 into pocket 212 of housing 94 and thereby draws arms 224, 226 of clamp 96 toward stay abutment surfaces 218, 220 of housing 94. Said in another way, tightening fastener 230 reduces the gap between clamp arms 224, 226 and housing 94 until the bicycle seat stays 70 are captured securely between housing 94 and clamp 96. Such a construction allows storage pack assembly 12 to be secured to the underlying bicycle 10 via interaction with only seat stays 70 while maintaining very near and preferably abutting engagement of storage pack assembly 12 with seat stem 20 or seat tube 22 of bicycle 10. Such a configuration also facilitates the interaction of storage pack assembly 12 with a number of bicycle shapes and configurations. That is, storage pack assembly 12 can be secured to bicycles having similar but not identical constructions.

Referring to FIGS. 4 and 5, when storage pack assembly 12 is attached to an underlying bicycle 10, storage pack assembly 12 forms a cross-sectional shape 250 that compliments the cross sectional shape of the seat stem 20 and/or seat tube 22 and thereby compliments the aerodynamic performance of the underlying bicycle The detrimental effects of an airflow, indicated by arrow 252, over the seat stem or seat tube 20, 22 is at least partially mitigated by the complementing shapes of the seat stem and/or tube 20, 22 and the storage pack assembly 12 which terminates at trailing edge 124 of storage pack assembly 12 and extends along side surfaces 120, 122 of housing 94.

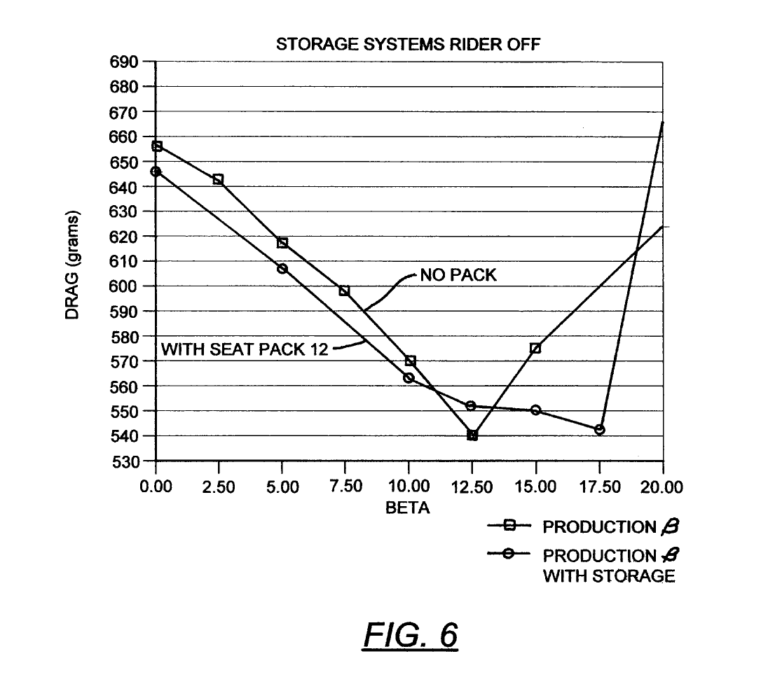

As graphically shown in FIG. 6, storage pack assembly 12 reduces the detrimental aerodynamic effects associated with attaching or otherwise supporting bicycle accessories relative to a bicycle at most air flow yaw angles that occur within most operating conditions. Air flow yaw angles are determined as deviations from airflows that are aligned with the longitudinal axis of bicycle 10. Said in another way, yaw air flows include lateral directional vectors and are at least partially directed to cross the longitudinal axis of bicycle 10. As shown in FIG. 6, a bicycle equipped with storage pack assembly 12 experiences drag measurements that are less than the drag measurements associated with aerodynamic testing of the same bicycle without storage pack assembly 12 at nearly all wind direction yaw angles. Accordingly, storage pack assembly 12 can dramatically improve the aerodynamic performance of a bicycle so equipped at most commonly occurring operating conditions.

Therefore, one embodiment of the invention includes a bicycle storage pack assembly. The storage pack assembly includes a housing defining a storage cavity and a forward facing wall having a shape that corresponds to a rearward facing wall of at least one of a seat tube and a seat post. A clamp body is movably connected to a bottom portion of the housing and has at least one arm that is shaped to engage a seat stay of a bicycle frame so that the seat stay can be captured between that the housing and the clamp body to secure the housing in abutting engagement with the one of the seat tube and the seat post by only the seat stays.

Another embodiment useable with one or more features of the above embodiment includes a bicycle accessory storage device having a container body adapted to be attached to a bicycle at a location generally rearward of a seat tube and between a seat stay and a saddle. The container body has a forward facing side wall that abuts a rearward facing side of the seat tube. The device includes a clamp engaged with a lower portion of the container body and movable relative to the container body to capture the seat stay between the clamp and the container body to maintain the forward facing side wall of the container in abutting engagement with the rearward facing side of the seat tube.

Another embodiment of the invention useable with one or more of the features above includes a method of providing a bicycle accessory storage system. The method includes forming a body to define a cavity for receiving at least one bicycle accessory and shaping the body to cooperate with a seat tube of the bicycle frame so that a horizontal cross section of the body compliments an aerodynamic shape of the seat tube. The method provides a clamp that movably cooperates with the body along an axis that is oriented in a crossing direction with respect to the horizontal cross section and so that a portion of the body extends laterally over an upper surface of a pair of seat stays and the clamp extends laterally over a lower surface of the pair of seat stays so that each of the seat stays are captured between the body and the clamp so that the bicycle accessory storage system is supported by only the seat stays.

The present invention has been described in terms of the preferred embodiment, and it is recognized that equivalents, alternatives, and modifications, beyond those expressly stated, are possible and within the scope of the appending claims.

What is claimed is:

1. A bicycle storage pack assembly comprising:
a housing defining a storage cavity and a forward facing wall having a shape that corresponds to a rearward facing wall of at least one of a seat tube and a seat post; and
a clamp body movably connected to a bottom portion of the housing, the clamp body having at least one arm shaped to engage a seat stay of a bicycle frame so that the seat stay can be captured between that the housing and the clamp body to secure the housing in abutting engagement with the one of the seat tube and the seat post by only the seat stays.

2. The bicycle storage pack assembly of claim 1 wherein the clamp body includes another arm that extends in an opposite direction from the at least one arm.

3. The bicycle storage pack assembly of claim 2 wherein the at least one arm engages an underside of one seat stay and the another arm engages an underside of another seat stay when secured to the bicycle frame.

4. The bicycle storage pack assembly of claim 3 further comprising a fastener that connects the housing and the clamp body and which extends between the one seat stay and another seat stay when secured to the bicycle frame.

5. The bicycle storage pack assembly of claim 1 further comprising a cover movably attached to the housing.

6. The bicycle storage pack assembly of claim 5 wherein the cover cooperates with an upper side of the housing.

7. The bicycle storage pack assembly of claim 5 further comprising a catch attached to the one of the cover and the housing by a living hinge and constructed to snap fittingly engage the other of the cover and the housing.

8. The bicycle storage pack assembly of claim 5 further comprising a lanyard extending between the cover the housing.

9. A bicycle accessory storage device comprising:
a container body adapted to be attached to a bicycle at a location generally rearward of a seat tube and between a seat stay and a saddle;
the container body having a forward facing side wall that abuts a rearward facing side of the seat tube; and
a clamp engaged with a lower portion of the container body and movable relative to the container body to capture the seat stay between the clamp and the container body to maintain the forward facing side wall of the container in abutting engagement with the rearward facing side of the seat tube.

10. The bicycle accessory storage device of claim 9 wherein a downward facing end of the container body includes a first curved surface and a second curved surface that extend in opposite lateral directions, the first curved surface and the second curved surface being shaped to abut the seat stay and another seat stay.

11. The bicycle accessory storage device of claim 10 wherein the clamp further comprises a first arm and a second arm that are each shaped in a generally mirror image of a respective one of the first curved surface and the second curved surface of the container.

12. The bicycle accessory storage device of claim 11 wherein each of the first arm and first curved surface and the second arm and the second curved surface attain an over-center orientation of a respective seat stay.

13. The bicycle accessory storage device of claim 9 further comprising a fastener that is operable from within the container body to alter a distance between the container body and the clamp.

14. The bicycle accessory storage device of claim 9 further comprising a cover that movably cooperates with an upper portion of the container body.

15. The bicycle accessory storage device of claim 14 further comprising a catch extending from each of opposite lateral side of the cover.

16. The bicycle accessory storage device of claim 15 further comprising an opening forming in each opposite lateral side of the container body, each opening shaped to cooperate with a corresponding catch of the cover.

17. The bicycle accessory storage device of claim 14 further comprising a flexible tether that connects the cover to the container body.

18. A method of providing a bicycle accessory storage system comprising:
forming a body to define a cavity for receiving at least one bicycle accessory;
shaping the body to cooperate with a seat tube of the bicycle frame so that a horizontal cross section of the body aerodynamically compliments a cross sectional shape of the seat tube;
providing a clamp that movably cooperates with the body along an axis that is oriented in a crossing direction with respect to the horizontal cross section and so that a portion of the body extends laterally over an upper surface of a pair of seat stays and the clamp extends laterally over a lower surface of the pair of seat stays so that each of the seat stays are captured between the body and the clamp so that the bicycle accessory storage system is supported by only the seat stays.

19. The method of claim 18 further comprising extending an adjustable fastener between the body and the clamp and orienting the adjustable fastener to be generally aligned with the crossing direction to alter a distance between the clamp and the body.

20. The method of claim 18 further comprising providing a cover that movably cooperates with the body to selectively close an upward directed opening defined by the body.

21. The method of claim 20 further comprising forming a pocket on one of the body and the cover and a catch that removably engages the pocket on the other of the body and the cover.

22. The method of claim 21 further comprising tethering the cover to the body so that the cover remains connected to the body but is movable with respect to the body between an open position wherein the catch is disengaged from the pocket and a closed position wherein the catch is engaged with the pocket.

23. The method of claim 20 further comprising forming at least one of the body, the clamp, and the cover from glass filled nylon material.
